(19) United States
(12) Patent Application Publication
(10) Pub. No.: US 2015/0219799 A1
(43) Pub. Date: Aug. 6, 2015

(54) OPTICAL MEMBER WITH ANTIREFLECTION FILM, AND METHOD OF MANUFACTURING THE SAME

(71) Applicant: FUJIFILM Corporation, Tokyo (JP)

(72) Inventors: Shinichiro SONODA, Ashigarakami-gun (JP); Shinya HAKUTA, Ashigarakami-gun (JP); Tatsuya YOSHIHIRO, Ashigarakami-gun (JP)

(73) Assignee: FUJIFILM Corporation, Tokyo (JP)

(21) Appl. No.: 14/685,994

(22) Filed: Apr. 14, 2015

Related U.S. Application Data
(63) Continuation of application No. PCT/JP2013/006049, filed on Oct. 10, 2013.

(30) Foreign Application Priority Data
Oct. 17, 2012 (JP) 2012-229874
Mar. 18, 2013 (JP) 2013-054850

(51) Int. Cl. G02B 1/118; G02B 1/18; G02B 1/12; G02B 1/02; G02B 1/115

(52) U.S. Cl. CPC G02B 1/118; G02B 1/02; G02B 1/115; G02B 1/12; G02B 1/18; B82Y 20/00

(57) ABSTRACT

An antireflection film including a transparent thin film layer, and a transparent fine uneven layer whose main component is an alumina hydrate, which layers are formed in this order on a surface of a transparent substrate, is provided. The transparent thin film layer includes, in order from the transparent substrate side: an alumina layer; a water barrier layer which has a refractive index lower than the refractive index of the alumina layer and protects the alumina layer from water; and a flat layer whose main component is an alumina hydrate and whose refractive index is lower than the refractive index of the water barrier layer, and the water barrier layer has a thickness of 70 nm or less.

### CROSS-REFERENCE TO RELATED APPLICATIONS

This application is a Continuation of PCT International Application No. PCT/JP2013/006049 filed on Oct. 10, 2013, which claims priority under 35 U.S.C. §119(a) to Japanese Unexamined Patent Application No. 2012-229874 filed on Oct. 17, 2012 and Japanese Unexamined Patent Application No. 2013-054850 filed on Mar. 18, 2013. Each of the above applications is hereby expressly incorporated by reference, in its entirety, into the present application.

### BACKGROUND OF THE INVENTION

1. Field of the Invention

The present invention relates to an optical member and a method of manufacturing the optical member, and in particular to an optical member provided with an antireflection film on a surface thereof and a method of manufacturing the optical member.

2. Description of the Related Art

Conventionally, lenses (transparent substrates) using a light-transmitting member, such as glass or plastic, are provided on the light entrance surface thereof with an antireflection structure (antireflection film) for reducing loss of the transmitted light due to surface reflection.

For example, as antireflection structures for visible light, a dielectric multi-layer film, a fine uneven structure having a pitch shorter than the wavelength of visible light, etc., are known (see, for example, Japanese Unexamined Patent Publication Nos. 2005-275372 and 2010-066704, which will hereinafter be referred to as Patent Literature 1 and 2, respectively).

Patent Literature 1 discloses an arrangement where a fine uneven film is formed on a substrate via a transparent thin film layer. The uneven film is mainly composed of alumina, and the transparent thin film layer contains at least one of zirconia, silica, titania, and zinc oxide. Patent Literature 1 teaches that the uneven film and the underlying transparent thin film layer are obtained by forming a multi-component film using a coating solution that at least contains an aluminum compound and a compound of at least one of zirconia, silica, titania, and zinc oxide, and performing a hot water treatment on the multi-component film.

Patent Literature 2 discloses an arrangement where a fine uneven film mainly composed of alumina is formed on a substrate via Al₂O₃ and SiO₂. Patent Literature 2 teaches in the “Prior Art” section that, as a method for growing boehmite, which is a hydroxide of aluminum, on a light-transmitting substrate, a method including forming an alumina film by vacuum deposition or a sol-gel method, and performing a steam treatment or a hot water treatment on the alumina film is used; however, Patent Literature 2 does not clearly describe the actual method used in the examples thereof.

### SUMMARY OF THE INVENTION

Patent Literature 1 teaches that the thickness of the fine uneven film can be controlled to be in the range from 0.005 to 5.0 μm, and the thickness of the transparent layer can be controlled to be in the range from 0.01 to 10 μm. It is assumed in Patent Literature 1 that a sol-gel method is used to form the multi-component film. However, sol-gel methods cannot be performed in batch processing and has a problem of low productivity.

Patent Literature 2 teaches that Al₂O₃ having a thickness of 80 nm and SiO₂ having a thickness of 100 nm are formed in this order on a substrate by evaporation, and then a fine uneven thin film mainly composed of alumina having a thickness of 300 nm is formed.

The present inventors have studied antireflection films which are assumed to be formed using a vapor deposition method, such as evaporation or sputtering, to improve productivity, and have found that none of the fine uneven structure films formed whose main component is alumina has a thickness greater than 150 nm (the details will be described later). This study has revealed that the above-mentioned layer structures and the film thicknesses cannot provide sufficient optical properties (antireflection property) when the uneven structure film has a thickness of 150 nm or less.

In view of the above-described circumstances, the present invention is directed to providing an optical member with an antireflection film which has sufficient optical properties and can be manufactured at high productivity, and a method of manufacturing the optical member.

An optical member of the invention is an optical member with an antireflection film,

the antireflection film comprising a transparent thin film layer, and a transparent fine uneven layer whose main component is an alumina hydrate, which layers are formed in this order on a surface of a transparent substrate,

wherein the transparent thin film layer comprises, in order from the substrate side: an alumina layer; a water barrier layer which has a refractive index lower than a refractive index of the alumina layer and protects the alumina layer from water; and a flat layer whose main component is an alumina hydrate and whose refractive index is lower than the refractive index of the water barrier layer, and

the water barrier layer has a thickness of 70 nm or less.

The “main component” as used herein is defined as a component whose content in weight % is the largest among components of a chemical structure contained in the relevant part.

It is preferred that the water barrier layer comprise a single layer or multiple layers, and at least one layer of the water barrier layer be made of any one of silica, silicon oxynitride, lanthanum fluoride, and gallium oxide.

It is preferred that the fine uneven layer have a thickness of 150 nm or less.

It is preferred that the layer made of any one of silica, silicon oxynitride, lanthanum fluoride, and gallium oxide of the water barrier layer have a thickness of 5 nm or more.

In this case, it is preferred that the transparent thin film layer be formed by reactive sputtering.

It is preferred that the layer made of any one of silica, silicon oxynitride, lanthanum fluoride, and gallium oxide of the water barrier layer have a thickness of 30 nm or more.

In this case, it is preferred that the transparent thin film layer be formed by evaporation.

A method of manufacturing the optical member of the invention is a method of manufacturing an optical member with an antireflection film, the antireflection film comprising a transparent thin film layer, and a transparent fine uneven layer whose main component is an alumina hydrate, which layers are formed in this order on a surface of a transparent substrate, the method comprising:

forming, on the transparent substrate, an alumina layer, a water barrier layer, and an alumina layer in this order by reactive sputtering; and

performing a hot water treatment on the transparent substrate with the layers formed thereon.

A method of manufacturing the optical member of the invention is a method of manufacturing an optical member with an antireflection film, the antireflection film comprising a transparent thin film layer, and a transparent fine uneven layer whose main component is an alumina hydrate, which layers are formed in this order on a surface of a transparent substrate, the method comprising:

forming, on the transparent substrate, an alumina layer, a water barrier layer, and an alumina layer in this order by evaporation; and

performing a hot water treatment on the transparent substrate with the layers formed thereon.

The optical member of the invention is an optical member with an antireflection film, the antireflection film including a transparent thin film layer, and a transparent fine uneven layer whose main component is an alumina hydrate, which layers are formed in this order on a surface of a transparent substrate, wherein the transparent thin film layer includes, in order from the transparent substrate side: an alumina layer; a water barrier layer which has a refractive index lower than the refractive index of the alumina layer and protects the alumina layer from water; and a flat layer whose main component is an alumina hydrate and whose refractive index is lower than the refractive index of the water barrier layer. The optical member of the invention can be formed by a vapor deposition method at high productivity. The water barrier layer having a thickness of 70 nm or less allows achieving an antireflection film (antireflection coating) with high antireflection performance.

### BRIEF DESCRIPTION OF THE DRAWINGS

FIG. 1 is a schematic sectional view illustrating the structure of an optical member according to a first embodiment,

FIG. 2 is a SEM image showing a fine uneven layer in plain view,

FIG. 3 is a SEM image showing the fine uneven layer in sectional view,

FIG. 4 shows the relationship among the thickness of an Al film formed, and the thicknesses of the fine uneven layer and a flat layer,

FIG. 5 shows the refractive index of the fine uneven layer and the flat layer,

FIG. 6 is a schematic sectional view illustrating the structure of an optical member according to a second embodiment,

FIG. 7 is a diagram for explaining a deposition angle (p,

FIG. 8 shows the dependency of a sum of reflectances on the thickness of Al₂O₃ when SiO₂ has a thickness of 20 nm,

FIG. 9 shows the dependency of a sum of reflectances on the thickness of Al₂O₃ when SiO₂ has a thickness of 40 nm,

FIG. 10 shows the dependency of a sum of reflectances on the thickness of Al₂O₃ when SiO₂ has a thickness of 60 nm,

FIG. 11 shows the dependency of a sum of reflectances on the thickness of Al₂O₃ when SiO₂ has a thickness of 80 nm,

FIG. 12 shows the dependency of a sum of reflectances on the thickness of SiO₂ when Al₂O₃ has a thickness of 80 nm,

FIG. 13 shows the dependency of the reflectance of a sample made by sputtering on the wavelength for each deposition angle,

FIG. 14 shows the dependency of the reflectance of another sample made by sputtering on the wavelength for each deposition angle, and

FIG. 15 shows the dependency of the reflectance of a sample made by evaporation on the wavelength for each deposition angle.

### DETAILED DESCRIPTION OF THE PREFERRED EMBODIMENTS

Hereinafter, embodiments of the present invention will be described with reference to the drawings.

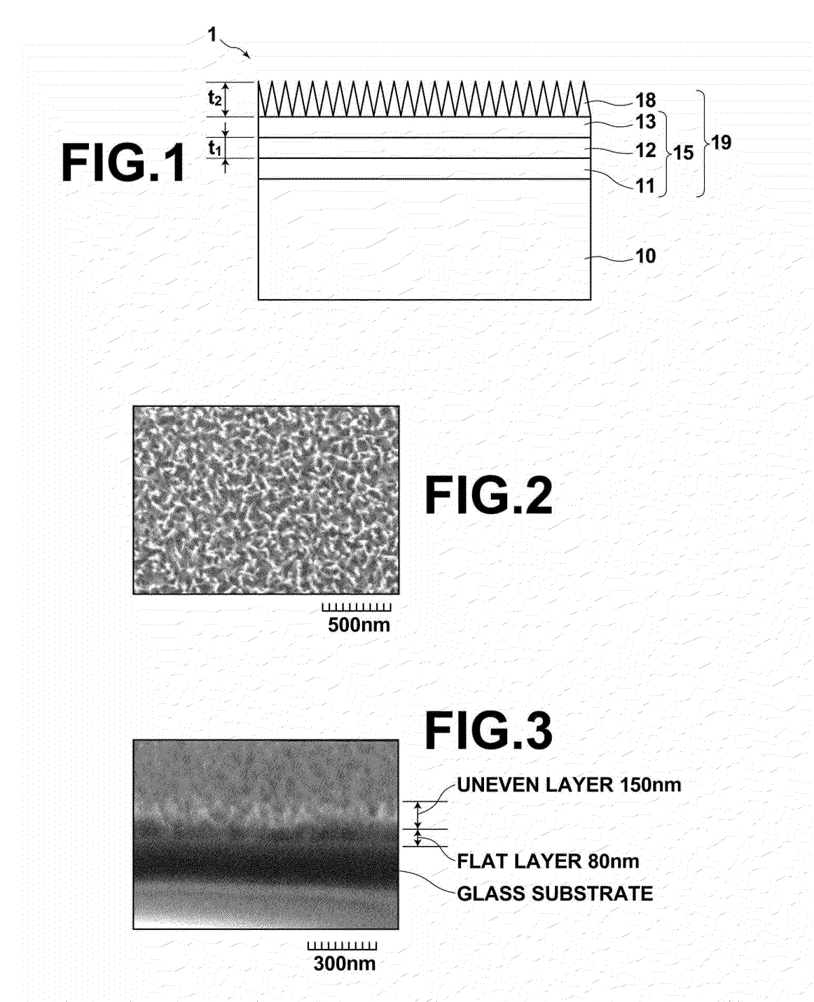

FIG. 1 is a schematic sectional view illustrating the structure of an optical member 1 according to a first embodiment of the invention. As shown in FIG. 1, the optical member 1 includes an antireflection film 19 formed on a surface of a transparent substrate 10, and the antireflection film 19 includes a transparent thin film layer 15, and a transparent fine uneven layer 18 whose main component is an alumina hydrate which are formed in this order on the transparent substrate 10. The transparent thin film layer 15 includes, in order from the substrate 10 side: an alumina layer 11; a water barrier layer 12 which has a refractive index lower than the refractive index of the alumina layer 11 and protects the alumina layer 11 from water; and a flat layer 13 whose main component is an alumina hydrate and whose refractive index is lower than the refractive index of the water barrier layer 12.

The water barrier layer 12 has a thickness t₁ of 70 nm or less. It should be noted that the water barrier layer 12 having a smaller thickness provides an antireflection film with better optical properties. On the other hand, in order to ensure a sufficient water barrier function to protect the underlying alumina layer 11, it is desirable that the water barrier layer have a thickness of 5 nm or more when it is formed by reactive sputtering, and have a thickness of 30 nm when it is formed by evaporation. The difference of film thickness is due to a difference of film quality between a thin film formed by reactive sputtering and a thin film formed by evaporation. Evaporated atoms during reactive sputtering have higher kinetic energies than those during evaporation and provide better film quality, which allows providing higher water barrier characteristics with a smaller film thickness.

In the case where the water barrier layer has a thickness of 5 nm or more, the underlying alumina layer is not converted into boehmite through the hot water treatment and functions as the water barrier layer.

The water barrier layer 12 may be formed by a single layer or multiple layers. It is desirable that at least one layer of the water barrier layer 12 be made of any one of silica (SiO₂), silicon oxynitride, lanthanum fluoride, and gallium oxide. The water barrier layer 12 includes all layers provided between the alumina layer 11 on the substrate 10 and the flat layer 13 whose main component is an alumina hydrate.

In the case where the water barrier layer 12 is formed by a single layer made of any one of silica (SiO₂), silicon oxynitride, lanthanum fluoride, and gallium oxide, the thickness of the water barrier layer 12 is 70 nm or less, and preferably 5 nm or more if it is formed by reactive sputtering, or 30 nm or more if it is formed by evaporation.

It should be noted that whether or not a layer provided between the alumina layer 11 and the flat layer 13 is equivalent to the water barrier layer can be checked by measuring the refractive index with a spectroscopic ellipsometer, or the like, to measure a change of the refractive index of the alumina layer 11 before and after the hot water treatment. Specifically, the refractive index of the alumina layer 11 before the hot water treatment is measured at each of 20 different points and the average value and the standard deviation of the measurements are calculated, and then the refractive index of the alumina layer 11 after the hot water treatment is measured at each of 20 different points and the average value and the standard deviation of the measurements are calculated. Then, whether or not there is a significant decrease of the refractive index is determined by conducting a significance test where the significance level is set at 5% to determine whether or not there is a significant difference between the refractive index before the hot water treatment and the refractive index of after the hot water treatment.

Examples of the alumina hydrate include boehmite (which is written as Al₂O₃.H₂O or AlOOH), which is alumina monohydrate, bayerite (which is written as Al₂O₃.3H₂O or Al(OH)₃), which is alumina trihydrate (aluminum hydroxide), etc.

The fine uneven layer 18 whose main component is an alumina hydrate is transparent, and has a substantially saw tooth-like cross-section, as shown in FIG. 1, etc., where the size (the magnitude of apex angle) and the orientation vary, though. The pitch (average pitch) of the fine uneven layer 18 is sufficiently smaller than the shortest wavelength in the wavelength range used, which is the wavelength range of the incoming light. The pitch of the fine uneven layer 18 refers to a distance between the apices of adjacent protrusions of the fine uneven structure with a recess therebetween, and the depth of the fine uneven layer 18 refers to a distance from the apices of protrusions to the bottoms of their adjacent recesses of the fine uneven structure.

The pitch of the fine uneven structure is on the order of several tens nanometers to several hundreds nanometers.

Further, an average depth (film thickness of the uneven layer) t₂ from the apices of the protrusions to the bottoms of their adjacent recesses in this embodiment is 150 nm or less.

The structure of the fine uneven layer is such that the structure is more sparse (i.e., the widths of voids which are equivalent to the recesses are larger and the widths of the protrusions are smaller) at a position farther away from the substrate, and the refractive index is lower at a position farther away from the substrate.

The average pitch of the uneven structure is found by taking a surface image of the fine uneven structure with a SEM (scanning electron microscope), binarizing the surface image by applying image processing, and applying statistical processing. Similarly, the film thickness of the uneven film is found by taking a cross-section image of the fine uneven layer, and applying image processing.

It is preferred to form the film using a vapor deposition method, such as evaporation or sputtering, which allows batch processing to improve the productivity. The present inventors have found through a study that, when evaporation or sputtering is used, the fine uneven layer can be formed by forming an aluminum film having a predetermined thickness and then performing a heat treatment; however, the thickness of the thus formed fine uneven layer is up to around 150 nm and a greater thickness cannot be obtained even when the thickness of the aluminum formed is changed.

Now, our study about the fine uneven layer is described.

An Al film was formed by sputtering on a glass substrate (EAGLE 2000, available from Corning Incorporated), and then immersed in boiling water for five minutes as the hot water treatment to form on the surface a fine uneven layer whose main component is an alumina hydrate.

FIG. 2 shows a SEM image of the thus made fine uneven layer in plain view, and FIG. 3 shows a SEM image of the fine uneven layer in sectional view.

As shown in FIGS. 2 and 3, the fine uneven layer was formed on the surface, and the flat layer was formed between the substrate and the uneven layer.

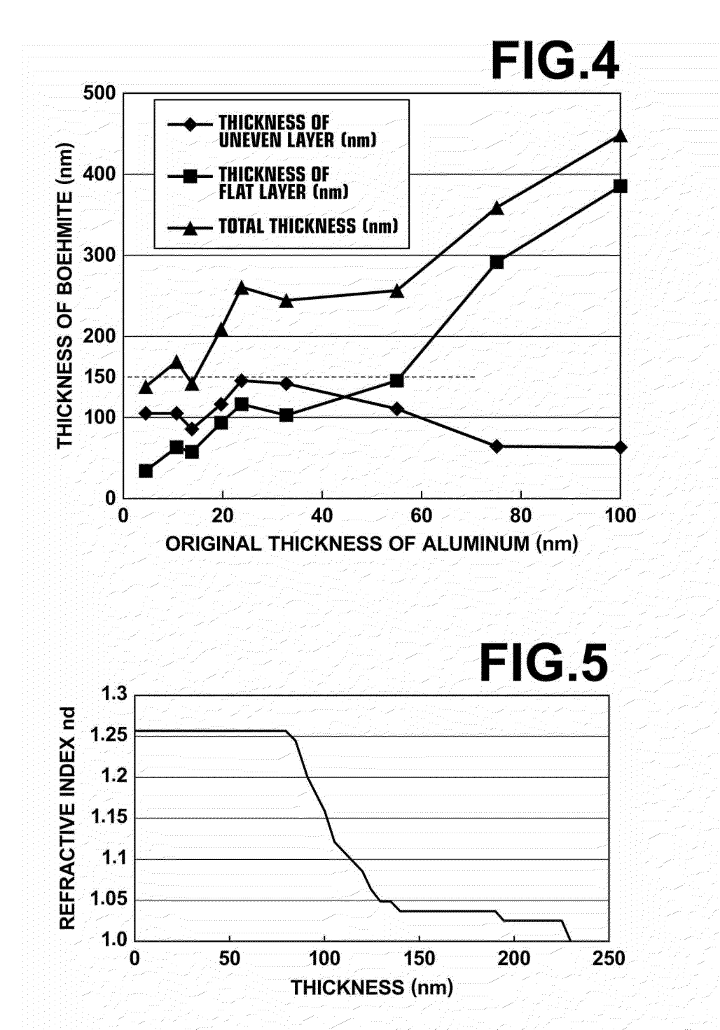

Changing the thickness of the Al film formed and performing the same hot water treatment, the relationship among the thickness of the Al film formed and the thicknesses of the fine uneven layer and the flat layer was examined, and the results are shown in FIG. 4.

As shown in FIG. 4, it was found that the thickness of the fine uneven layer is 150 nm or less even when the thickness of the Al film formed is increased. Although the cases where an Al film was formed and subjected to the hot water treatment to form boehmite are shown in FIG. 4, similar data was obtained in cases where an Al₂O₃ film was formed in place of Al and subjected to the hot water treatment to form boehmite. Also, similar data was obtained when evaporation was used in place of sputtering to form an Al film.

Further, the refractive index of a boehmite layer (the fine uneven layer and the flat layer), which was formed by forming an Al₂O₃ film having a thickness of 30 nm on Si and performing the hot water treatment, was measured with a spectroscopic ellipsometer, and the obtained results are shown in FIG. 5. In FIG. 5, the thickness of 0 corresponds to the surface position of the substrate, and the thickness of 230 nm where the refractive index is 1 corresponds to the surface position of the uneven structure layer.

As shown in FIG. 5, the refractive index nd of the flat layer had a constant value of 1.26, and the flat layer had a thickness of about 80 nm. The refractive index of the uneven layer was such that a portion of the uneven layer farther away from the substrate had a lower effective refractive index, and the uneven layer had a thickness of 150 nm. The total film thickness was 230 nm.

The relationship among a refractive index n₀ of the transparent substrate 10, a refractive index n₁ of the alumina layer 11, a refractive index n₂ of the water barrier layer 12, a refractive index n₃ of the flat layer 13, and a refractive index n₄ of the uneven layer is n₀>n₁>n₂>n₃>n₄, and the refractive index of the transparent thin film layer gradually decreases from a refractive index close to the refractive index of the transparent substrate, such as a lens, to a refractive index close to the refractive index of air. The refractive index n₄ of the uneven layer in the above inequality is an average refractive index of the entire uneven layer.

However, the fine uneven layer obtained after the hot water treatment of the film formed by sputtering has a thickness of 150 nm or less, as described above, and this is not sufficient for providing a sufficient antireflection effect. To address this problem, the present inventors have considered providing, between the fine uneven structure and the substrate, a layer having an intermediate refractive index between the refractive indices of the fine uneven structure and the substrate. To this end, a substrate having a refractive index higher than the refractive index of alumina is used, and first an Al₂O₃ (n=1.67) film is formed on the substrate.

However, if Al is sputtered on the Al₂O₃ film and is subjected to the hot water treatment, the Al₂O₃ film on the substrate is also converted into boehmite and cannot maintain the expected refractive index.

To address this problem, a barrier layer is provided between the Al₂O₃ film on the substrate and the Al (or Al₂O₃) film for forming the uneven layer so that the Al₂O₃ film on the substrate is not converted into hydrate (boehmite) through the hot water treatment. At this time, SiO₂ (silica) is used in this example as a material having a water barrier function, and the film thicknesses of Al₂O₃ and SiO₂ are controlled to form an antireflection structure using interference effect.

In the case where the antireflection film is formed by evaporation, the structure of the antireflection film of this embodiment can be formed using only two evaporation materials which includes Al₂O₃ and any one of silica, silicon oxynitride, lanthanum fluoride, and gallium oxide.

In Patent Literature 2, an interference structure is embodied as a structure including a substrate, an Al₂O₃ film, a SiO₂ film, and a fine uneven layer, where the thickness of SiO₂ is around 100 nm (n=1.5, an optical path length of about λ/4 of incoming light having a wavelength λ=600 nm). In the invention, it has been found that reducing the film thickness of SiO₂ to 70 nm or less improves the antireflection effect (see examples described later).

Further, it has been found that, in the case where the transparent thin film layer is formed by sputtering, the layer made of any one of silica, silicon oxynitride, lanthanum fluoride, and gallium oxide should have a thickness of 5 nm or more, preferably 7 nm or more, and more preferably 20 nm or more, and in the case where the transparent thin film layer is formed by evaporation, the layer made of any one of silica, silicon oxynitride, lanthanum fluoride, and gallium oxide should preferably have a thickness of 30 nm or more. Still further, the present inventors have found through an intensive study that, when the uneven film is formed on the surface by performing the hot water treatment after each layer is formed by sputtering or evaporation, the fine uneven film whose main component is an alumina hydrate has a film thickness of 150 nm or less, and a layer (flat layer) whose main component is an alumina hydrate and whose refractive index is almost uniform in the thickness direction is formed under the fine uneven film.

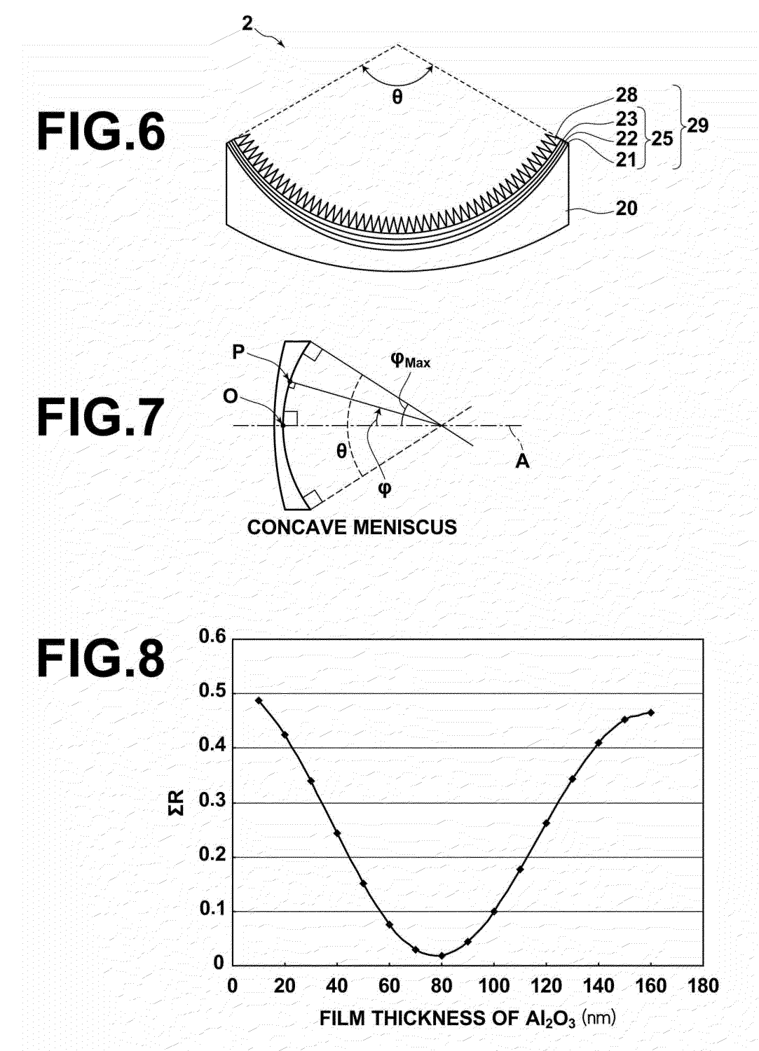

FIG. 6 is a schematic sectional view illustrating the structure of an optical member 2 according to a second embodiment of the invention. As shown in FIG. 6, the optical member 2 includes: a meniscus lens with curved surfaces as the transparent substrate 20; and an antireflection film 29 formed on the concave surface of the meniscus lens, the antireflection film 29 including a transparent thin film layer 25, and a transparent fine uneven layer 28 whose main component is an alumina hydrate, which are formed in this order on the concave surface. The transparent thin film layer 25 includes, in order from the substrate 20 side: an alumina layer 21; a water barrier layer 22 which has a refractive index lower than the refractive index of the alumina layer 21 and protects the alumina layer 21 from water; and a flat layer 23 whose main component is an alumina hydrate and whose refractive index is lower than the refractive index of the water barrier layer 22.

It is particularly preferred that the curved surface (concave surface) of the transparent substrate 20 is such that an angle θ between lines normal to the opposite ends of the curved surface, which is cut as the effective optical surface of the lens, exceeds 90°.

In the case where the surface on which the antireflection film 29 is formed is a curved surface, as in this embodiment, forming the antireflection film 29 by evaporation or sputtering results in a film having the largest film thickness at the center portion of the curved surface and a smaller film thickness at a portion closer to the peripheral portion. FIG. 7 is a diagram for explaining a deposition angle φ for forming the thin film layer on the curved surface of the concave surface of a meniscus lens. As shown in FIG. 7, the evaporation source or sputtering target is disposed to face the lens at a position along a line A normal to the center O of the lens. It is assumed here that the evaporation source or sputtering target is a point source. The deposition angle φ is defined as an angle between the normal line A and a line normal to each position P on the lens surface. According to this definition, the deposition angle φ for the center position O of the lens surface is 0°, and the deposition angle φ for the end positions of the curved surface is a maximum deposition angle φ_{Max}. It should be noted that θ is twice the maximum deposition angle φ_{Max}. The number of particles incident on each surface position is proportional to cos φ of the deposition angle φ during evaporation or sputtering. That is, the film thickness at the peripheral portion of the lens is smaller than the film thickness at the center position of the lens.

The layer made of any one of silica, silicon oxynitride, lanthanum fluoride, and gallium oxide has a thickness of 70 nm or less across its entire area.

In the case where the transparent thin film layer is formed on a curved surface by sputtering, it is preferred that the layer made of any one of silica, silicon oxynitride, lanthanum fluoride, and gallium oxide have a film thickness of 5 nm or more at the peripheral portion, where the film thickness of the layer is the smallest. In the case where the transparent thin film layer is formed on a curved surface by evaporation, it is preferred that the layer made of any one of silica, silicon oxynitride, lanthanum fluoride, and gallium oxide have a film thickness of 30 nm or more at the peripheral portion, where the film thickness of the layer is the smallest.

### EXAMPLES

Now, simulations and examples of the structure of the invention are described.

### Simulations

Simulations have been performed by multi-layer calculation of a case where an antireflection film including an Al₂O₃ layer, a SiO₂ layer, a boehmite layer (flat layer) having a film thickness of 80 nm and a refractive index nd=1.26, and a uneven boehmite layer (fine uneven layer) having a film thickness of 150 nm are formed on a curved lens surface having a radius of curvature of 36.4 mm of a glass material OHARA S-LAH58 (nd=1.88300) with a maximum φ=62.5°.

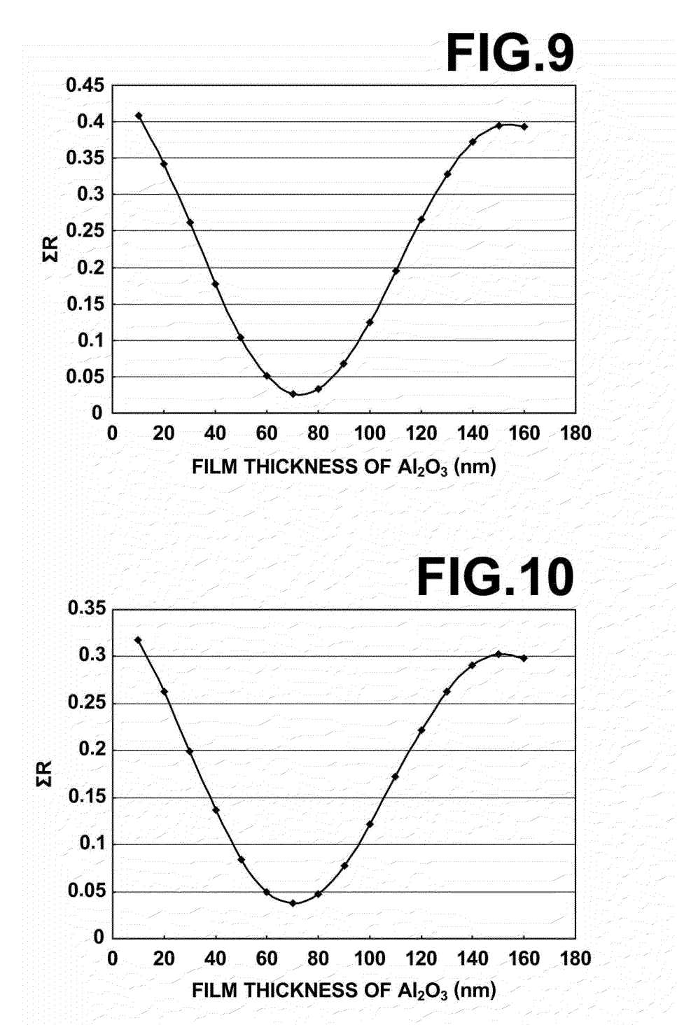

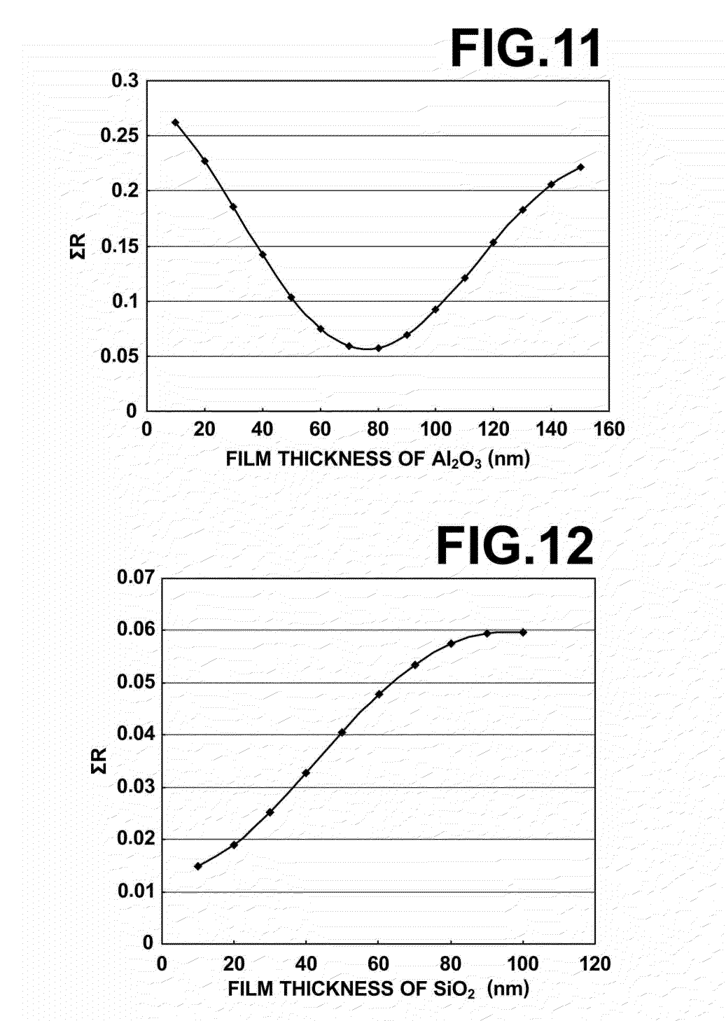

Changing the film thickness of Al₂O₃ on the substrate in the range from 10 to 200 nm, and changing the film thickness of SiO₂ serving as the water barrier layer in the range from 10 to 100 nm, the sum of reflectances for incoming light of a wavelength ranging from 450 to 700 nm at an increment of 10 nm is examined. It should be noted that the film thickness here refers to the film thickness at the center portion of a lens, which is the largest film thickness. The multi-layer calculation is performed using a thin film calculation software application, ESSENTIAL MACLEOD. FIGS. 8 to 11 show part of the results.

FIGS. 8 to 11 show the dependency of the sum of reflectances (ΣR) on the film thickness of Al₂O₃ when the thickness of SiO₂ is 20 nm, 40 nm, 60 nm, and 80 nm, respectively. As shown in FIGS. 8 to 11, the reflectance is the lowest when the thickness of the Al₂O₃ layer is around 70 to 80 nm for any of the film thicknesses of SiO₂.

On the other hand, FIG. 12 is a graph showing the dependency of the sum of reflectances (ΣR) on the film thickness of SiO₂ when the thickness of the Al₂O₃ layer is 80 nm. As shown in FIG. 12, the reflectance is the highest when the thickness of SiO₂ is 100 nm, and it has been found that, when the film thickness of the SiO₂ layer is 100 nm or less, a smaller film thickness of the SiO₂ layer provides a better result. In particular, decrease of the reflectance along with decrease of the film thickness becomes steeper when the film thickness is around 70 nm or less, and it is clear that the film thickness of the SiO₂ layer is preferably 70 nm or less, and more preferably 50 nm or less.

It should be noted that, although the case where SiO₂ is used to form the barrier layer is studied in the simulations, it is believed that a smaller film thickness of the water barrier layer also provides higher performance when the water barrier layer is made of any one of silicon oxynitride, lanthanum fluoride, and gallium oxide.

### Example 1

Using an ECR (electron cyclotron resonance) sputtering apparatus, an Al₂O₃ layer, a SiO₂ layer, and an Al₂O₃ layer were formed in this order on a curved lens surface having a radius of curvature of 36.4 mm of a glass material OHARA S-LAH58 (nd=1.88300) with a maximum φ=62.5°. At this time, each of the SiO₂ and Al₂O₃ layers was formed by DC sputtering using Si and Al targets, respectively, and using O₂ as an assist gas.

After the uppermost Al₂O₃ layer having a film thickness of 30 nm was formed, a hot water treatment was performed by immersing the layers in boiling water for five minutes. Through the hot water treatment, the uppermost Al₂O₃ layer was converted into a boehmite layer (flat layer) having a film thickness of 80 nm and a refractive index nd=1.26, and a uneven boehmite layer (fine uneven layer) having a film thickness of 150 nm. It should be noted that the film thickness here refers to the film thickness at the center portion of the lens, which is the largest film thickness.

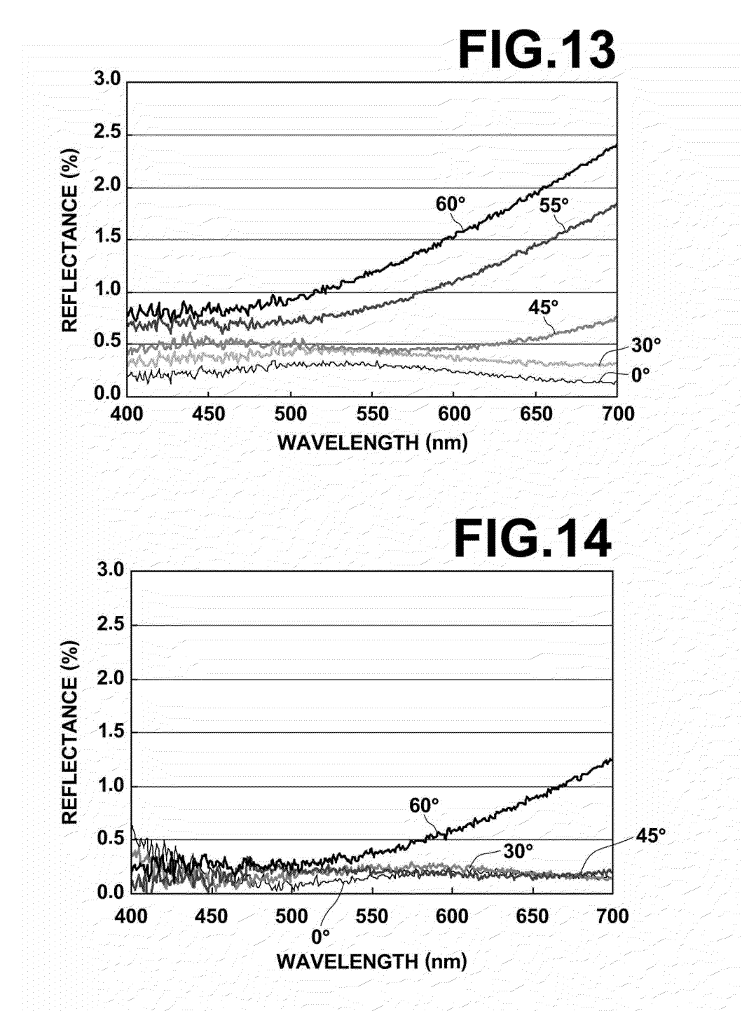

With respect to a sample prepared under the above-described conditions where the Al₂O₃ on the substrate had a film thickness of 80 nm, and the SiO₂ serving as the water barrier layer had a film thickness of 10 nm, reflectance for incoming light at an incident angle of 0° was measured at each of positions corresponding to deposition angles φ of 0°, 30°, 45°, 55°, and 60°. The results are shown in FIG. 13.

As shown in FIG. 13, a relatively good reflection reduction effect was obtained at positions corresponding to the deposition angles up to φ=60°. A reflectance of 2.0% or less was achieved at least across the wavelength range from 400 to 650 nm. It is therefore believed that the water barrier characteristics are ensured when the film thickness of the SiO₂ layer is 10 nm×cos 60°=5 nm or more. That is, in the case where the layer is formed by sputtering, the water barrier characteristics are ensured when the water barrier layer has a film thickness of 5 nm or more across the entire area of the substrate on which the antireflection film is formed. Further, at positions corresponding to the deposition angles of φ=45° or less, a reflectance of 1% or less was achieved across the wavelength range from 400 nm to 700 nm, which is more preferred. In other words, it is more preferred that the film thickness of the SiO₂ layer be 10 nm×cos 45°≈7, or about 7 nm or more across the entire area of the substrate on which the antireflection film is formed.

Further, with respect to a sample where the Al₂O₃ on the substrate has a film thickness of 80 nm and the SiO₂ has a film thickness of 40 nm among samples prepared as described above, reflectance for incoming light at an incident angle of 0° was measured at each of positions corresponding to deposition angles φ of 0°, 30°, 45°, and 60°. The results are shown in FIG. 14.

As shown in FIG. 14, a good reflection reduction effect was obtained at positions corresponding to the deposition angles up to φ=60°. With this sample, even lower reflection characteristics than the case shown in FIG. 13 were obtained, and it was found that the film thickness of the SiO₂ film (the largest thickness thereof at the center portion) of 40 nm is more preferred than the film thickness of 10 nm.

In this case, 40 nm×cos 60°=20 nm, and it is preferred that the SiO₂ film have a thickness of 20 nm or more across the entire area on which the antireflection film is formed.

### Example 2

Using an EB (electron beam) vapor deposition apparatus, an Al₂O₃ layer, a SiO₂ layer, and an Al₂O₃ layer were formed in this order on a curved lens surface with a radius of curvature of 36.4 mm of a glass material OHARA S-LAH58 (nd=1.88300) with a maximum φ=62.5°. At this time, each of the SiO₂ and Al₂O₃ layers was formed by applying electron beams from an EB gun to each evaporation source, which were SiO₂ and Al₂O₃ pellets, respectively.

After the uppermost Al₂O₃ layer having a film thickness of 30 nm was formed, a hot water treatment was performed by immersing the layers in boiling water for five minutes. Through the hot water treatment, the uppermost Al₂O₃ layer was converted into a boehmite layer (flat layer) having a film thickness of 80 nm and a refractive index n=1.26, and a uneven boehmite layer (fine uneven layer) having a film thickness of 150 nm.

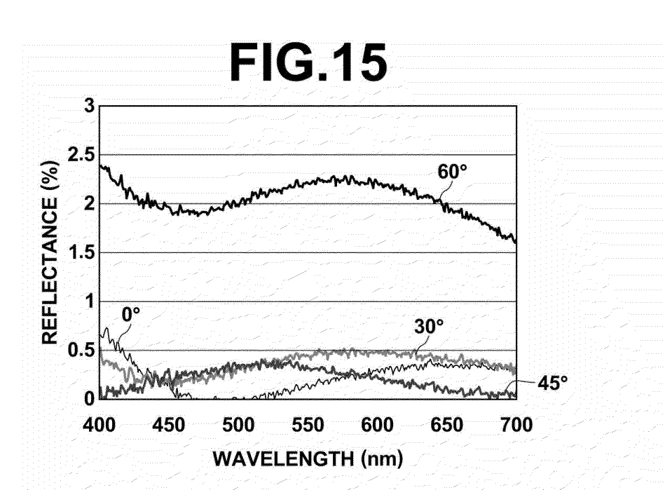

With respect to a sample prepared under the above-described conditions where the Al₂O₃ on the substrate had a film thickness of 80 nm, and the SiO₂ serving as the water barrier layer had a film thickness of 40 nm, reflectance for incoming light at an incident angle of 0° was measured at each of positions corresponding to deposition angles φ of 0°, 30°, 45°, and 60°. The results are shown in FIG. 15.

As shown in FIG. 15, the reflectance was significantly higher at the position corresponding to the deposition angle φ=60°. The reason is believed that the film thickness is small and an appropriate interference effect cannot be obtained at a position corresponding to a large φ, and that portions of the SiO₂ film at positions corresponding to high deposition angles have a columnar structure and the Al₂O₃ on the substrate is altered through the hot water treatment when the film thickness of the SiO₂ film is small. On the other hand, at positions corresponding to the deposition angles of φ=45° or less, a low reflectance of 0.5% or less was achieved for the wavelength range from 400 to 700 nm. It is therefore believed that, in the case where evaporation is used, the water barrier characteristics are ensured when the water barrier layer has a thickness of 40 nm×cos 45°≈30 nm, or about 30 nm or more. In other words, in the case where the layer is formed by evaporation, it is believed that the water barrier characteristics are ensured and a sufficient antireflection function is obtained when the water barrier layer has a film thickness of 30 nm or more across the entire area of the substrate on which the antireflection film is formed.

### Example 3

An alumina thin film having a thickness of 70 nm was formed by reactive sputtering on a glass substrate with high refractive index, S-LAH55V (available from Ohara Inc.), and a silica film having a thickness of 5 nm was formed by reactive sputtering as the water barrier layer on the alumina thin film, and then the hot water treatment was performed. The refractive index of the alumina layer before and after the hot water treatment was measured with a spectroscopic ellipsometer, and the refractive index of the alumina layer was found to be 1.65 both before and after the hot water treatment. It is clear from this result that silica is suitable as the water barrier layer.

It should be noted that, in this example, a spectroscopic ellipsometer, MASS, available from Five Lab Co., Ltd., was used to measure a phase difference Δ between fresnel reflection coefficients for S and P polarizations and an arc tangent φ of an amplitude ratio of the fresnel reflection coefficients of S and P polarizations. Then, the refractive index was calculated based on the Δ and the φ using an analysis software application bundled with the spectroscopic ellipsometer MASS. It should be noted that the refractive index was measured in the above-described manner in Examples 4 and 5 and Comparative Example, which are described below.

### Example 4

An alumina thin film having a thickness of 70 nm was formed by reactive sputtering on a glass substrate with high refractive index, S-LAH55V (Ohara Inc.), and a silicon oxynitride film having a thickness of 5 nm was formed by reactive sputtering as the water barrier layer on the alumina thin film, and then the hot water treatment was performed. The refractive index of the alumina layer before and after the hot water treatment was measured with a spectroscopic ellipsometer, and the refractive index of the alumina layer was found to be 1.70 both before and after the hot water treatment. It is clear from this result that silicon oxynitride is suitable as the water barrier layer.

### Example 5

An alumina thin film having a thickness of 70 nm was formed by reactive sputtering on a glass substrate with high refractive index, S-LAH55V (Ohara Inc.), and a lanthanum fluoride layer having a thickness of 40 nm was formed by evaporation as the water barrier layer on the alumina thin film, and then the hot water treatment was performed. The refractive index of the alumina layer before and after the hot water treatment was measured with a spectroscopic ellipsometer, and the refractive index of the alumina layer was found to be 1.65 both before and after the hot water treatment. It is clear from this result that the lanthanum fluoride layer is suitable as the water barrier layer.

### Example 6

An alumina thin film having a thickness of 70 nm was formed by reactive sputtering on a glass substrate with high refractive index, S-LAH55V (Ohara Inc.), and a gallium oxide layer having a thickness of 40 nm was formed by evaporation as the water barrier layer on the alumina thin film, and then the hot water treatment was performed. The refractive index of the alumina layer before and after the hot water treatment was measured with a spectroscopic ellipsometer, and the refractive index of the alumina layer was found to be 1.65 both before and after the hot water treatment. It is clear from this result that the gallium oxide layer is suitable as the water barrier layer.

### Comparative Example

An alumina thin film having a thickness of 70 nm was formed by reactive sputtering on a glass substrate with high refractive index, S-LAH55V (Ohara Inc.), and the hot water treatment was performed. The refractive index of the alumina layer before and after the hot water treatment was measured with a spectroscopic ellipsometer; however, the refractive index of the alumina layer was not able to be calculated. The reason is believed that the alumina layer was converted into a boehmite layer having a continuously varying refractive index through the hot water treatment. It is clear from this result that a preferred refractive index of the alumina layer cannot be achieved without the water barrier layer.

What is claimed is:

1. An optical member with an antireflection film,
the antireflection film comprising a transparent thin film layer, and a transparent fine uneven layer whose main component is an alumina hydrate, which layers are formed in this order on a surface of a transparent substrate,
wherein the transparent thin film layer comprises, in order from the substrate side: an alumina layer; a water barrier layer which has a refractive index lower than a refractive index of the alumina layer and protects the alumina layer from water; and a flat layer whose main component is an alumina hydrate and whose refractive index is lower than the refractive index of the water barrier layer, and
the water barrier layer has a thickness of 70 nm or less.

2. The optical member as claimed in claim 1, wherein the water barrier layer comprises a single layer or multiple layers, and at least one layer of the water barrier layer is made of any one of silica, silicon oxynitride, lanthanum fluoride, and gallium oxide.

3. The optical member as claimed in claim 1, wherein the fine uneven layer has a thickness of 150 nm or less.

4. The optical member as claimed in claim 2, wherein the layer made of any one of silica, silicon oxynitride, lanthanum fluoride, and gallium oxide of the water barrier layer has a thickness of 5 nm or more.

5. The optical member as claimed in claim 4, wherein the transparent thin film layer is formed by reactive sputtering.

6. The optical member as claimed in claim 2, wherein the layer made of any one of silica, silicon oxynitride, lanthanum fluoride, and gallium oxide of the water barrier layer has a thickness of 30 nm or more.

7. The optical member as claimed in claim 6, wherein the transparent thin film layer is formed by evaporation.

8. A method of manufacturing an optical member with an antireflection film, the antireflection film comprising a transparent thin film layer, and a transparent fine uneven layer whose main component is an alumina hydrate, which layers are formed in this order on a surface of a transparent substrate, the method comprising:
forming, on the transparent substrate, an alumina layer, a water barrier layer, and an alumina layer in this order by reactive sputtering; and
performing a hot water treatment on the transparent substrate with the layers formed thereon.

9. A method of manufacturing an optical member with an antireflection film, the antireflection film comprising a transparent thin film layer, and a transparent fine uneven layer whose main component is an alumina hydrate, which layers are formed in this order on a surface of a transparent substrate, the method comprising:
forming, on the transparent substrate, an alumina layer, a water barrier layer, and an alumina layer in this order by evaporation; and
performing a hot water treatment on the transparent substrate with the layers formed thereon.
